(19) United States
(12) Patent Application Publication
(10) Pub. No.: US 2026/0244853 A1
(43) Pub. Date: Aug. 20, 2026

(54) AUTOMATED NEWS CURATION

(71) Applicant: ITERATE STUDIO, INC., Highlands Ranch, CO (US)

(72) Inventors: Jon NORDMARK, Littleton, CO (US); Quin NORDMARK, Highlands Ranch, CO (US); Daniel Richard WERLING, Monument, CO (US); Gen William FURUKAWA, Austin, TX (US)

(21) Appl. No.: 19/543,658

(22) Filed: Feb. 18, 2026

Related U.S. Application Data
(60) Provisional application No. 63/760,006, filed on Feb. 18, 2025.

(51) Int. Cl. G06F 40/186; G06F 16/34; G06F 16/9535

(52) U.S. Cl. CPC G06F 40/186; G06F 16/345; G06F 16/9535

(57) ABSTRACT

Apparatuses, systems, and methods for automated news curation are disclosed. Articles are automatically gathered, parsed, ranked, sorted, and summarized to generate newsletters. The articles can be news stories that are located on websites or webpages, blogs, social media sites, applications, magazines, and other news sources. The newsletters can be transmitted to recipients by email, text messages, instant messages, posted on social media sites, posted on blogs, posted on websites, or via another type of electronic communication system. The newsletters may include text, graphics, images, videos, audio, hyperlinks, announcements (e.g., advertisements), and the like. A template for a newsletter is populated with content that includes some or all of the summaries. Once generated, the newsletters are automatically transmitted to recipients.

### CROSS-REFERENCE TO RELATED APPLICATIONS

This application claims the benefit of priority pursuant to 35 U.S.C. § 119(e) of U.S. Provisional Patent Application No. 63/760,006, filed Feb. 18, 2025, titled “Automated News Curation,” which is hereby incorporated by reference herein in its entirety.

### BACKGROUND

The amount of news currently available to users is substantial. A user does not have the time to find and access (e.g., watch or read) news stories from all news sources that are related to the topic or topics that interest the user. News aggregation services search out and aggregate news content published on web pages throughout the Internet. A news aggregation service typically presents a list of news stories from the aggregated new content. The list of news stories typically presents each news story by a title of the news story or an incomplete sentence from within the news story.

### BRIEF SUMMARY

In an embodiment, a computer-implemented method for automated newsletter generation is disclosed. The method includes: identifying, via a processor, based on a title of a newsletter, a plurality of articles that are associated with a topic, at or near a publication date of the newsletter; generating, via the processor, a ranking of the plurality of articles based on relevancy scores associated with each article in the plurality of articles that indicate how relevant each article is to the topic, wherein the ranking of the plurality of articles utilizes a first prompt for a platform that comprises an artificial intelligence tool; generating, via the processor, a plurality of summaries of the plurality of articles, wherein each summary of the plurality of summaries is for one of the plurality of articles, and wherein the generating of the plurality of summaries utilizes a second prompt for the platform; generating, via the processor, the newsletter by populating a newsletter template associated with the newsletter with content to produce the newsletter, wherein the content comprises at least a portion of the plurality of summaries of the plurality of articles, wherein the at least the portion of the plurality of summaries of the plurality of articles is based on the ranking of the plurality of articles; and transmitting, via the processor, the newsletter to an output channel to be received by a plurality of recipients.

Optionally, in some embodiments, the method further includes receiving a request to receive the newsletter from each of the plurality of recipients.

Optionally, in some embodiments, the method further includes receiving one or more edits to the newsletter prior to transmitting the newsletter to the output channel.

Optionally, in some embodiments, the method further includes: receiving, from an editor device, a user input to the ranking prior to generating the plurality of summaries of the plurality of articles; and modifying the ranking based on the user input.

Optionally, in some embodiments, the method further includes: receiving, from an editor device, a user input to a summary of the plurality of summaries of the plurality of articles prior to generating the newsletter; and modifying the summary based on the user input.

Optionally, in some embodiments, the method further includes: deleting a first summary in the plurality of summaries of the plurality of articles based on a similarity of the first summary to a second summary in the plurality of summaries of the plurality of articles.

Optionally, in some embodiments, the method further includes: receiving, from an editor device, a user input to the newsletter prior to automatically transmitting the newsletter to the output channel; and modifying the newsletter based on the user input.

Optionally, in some embodiments, the content further comprises an announcement.

Optionally, in some embodiments, the announcement comprises an advertisement that is related to the topic.

Optionally, in some embodiments, identifying the plurality of articles associated with the topic comprises: utilizing the platform to determine the topic based on the title of the newsletter; and utilizing the platform to identify the plurality of articles based on the topic.

Optionally, in some embodiments, the method further includes: generating the first prompt based on a first prompt template and the topic.

Optionally, in some embodiments, the method further includes: generating the newsletter template prior to generating the newsletter, wherein generating the newsletter template comprises: generating a user interface configured to: display one or more sections of the newsletter template, comprising a title section and a content section; and receive a user input to modify the one or more sections of the newsletter template; and transmitting the user interface to an editor device.

Optionally, in some embodiments, the content section comprises a placeholder section for one or more of an article title, a placeholder section for an article summary, a placeholder section for an article hyperlink, a placeholder section for an announcement, and a placeholder section for an advertisement.

Optionally, in some embodiments, the user interface is configured to receive a drag and drop editing user input.

Optionally, in some embodiments, the user interface is configured to display a user interface element corresponding to the one or more sections of the newsletter template, wherein the user interface element is configured to receive code editing user input.

Optionally, in some embodiments, receiving the user input comprises: generating a user interface configured to: display a title section and a content section of the newsletter; display a user interface element corresponding to the title section and content section of the newsletter, wherein the user interface element is configured to receive code editing user input; and receive a user input to modify the title section or content section of the newsletter; and transmitting the user interface to the editor device.

Optionally, in some embodiments, the one or more user interface elements are configured to receive code input instructing modifications to the corresponding one or more sections of the newsletter; and the one or more user interface elements are configured to receive code input formatted in at least one of an HyperText Markup Language (HTML), Cascading Style Sheets (CSS), or JAVA format.

Optionally, in some embodiments, the content section comprises one or more of a section for an article title, a section for an article summary, a section for an article hyperlink, a section for an announcement, and a section for an advertisement.

In another embodiment, a computer-implemented method for automated newsletter generation is disclosed. The method includes: automatically receiving a plurality of articles that are associated with a topic, each of the plurality of articles associated with one or more titles for a plurality of newsletters; for each title of the one or more titles: automatically receiving a ranking of a portion of articles in the plurality of articles that are associated with the title, the ranking based on relevancy scores associated with each article in the portion of articles that indicate how relevant each article is to the title, the ranking produced using a first prompt or topic filter for a platform that comprises an artificial intelligence tool; automatically receiving summaries of the portion of articles, wherein each summary of the summaries is for one of the portion of articles, the summaries produced using a second prompt for the platform; automatically populating a newsletter template associated with the title with content to produce a newsletter, wherein the content comprises at least a portion of the summaries of the portion of the articles and the at least the portion of the summaries is based on the ranking of each article in the portion of articles; and automatically transmitting the newsletter to an output channel to be received by a plurality of recipients.

In another embodiment, an automated newsletter generation system is disclosed. The system includes: a processor; and a non-transitory computer-readable memory storing instructions that, when executed by the processor, cause the processor to: identify, based on a title of a newsletter, a plurality of articles that are associated with a topic at or near a publication date of the newsletter; generate a ranking of the plurality of articles based on relevancy scores associated with each article in the plurality of articles that indicate how relevant each article is to the topic, wherein the ranking of the plurality of articles utilizes a first prompt for a platform that comprises an artificial intelligence tool; generate a plurality of summaries of the plurality of articles, wherein each summary of the plurality of summaries is for one of the plurality of articles, and wherein the generating of the plurality of summaries utilizes a second prompt for the platform; generate the newsletter by populating a newsletter template associated with the newsletter with content to produce the newsletter, wherein the content comprises at least a portion of the summaries of the plurality of articles, wherein the at least the portion of the summaries of the plurality of articles is based on the ranking of the plurality of articles; and transmit the newsletter to an output channel to be received by a plurality of recipients.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the Figures.

FIG. 1 illustrates a flowchart of an example method of news curation according to an embodiment of the disclosure;

FIGS. 2A-2B illustrate a flowchart of an example method of news curation according to an embodiment of the disclosure;

FIG. 3A illustrates an example prompt for summarizing an article according to an embodiment of the disclosure;

FIG. 3B illustrates an example prompt for rewriting a summary of an article according to an embodiment of the disclosure;

FIG. 3C illustrates an example prompt for analyzing an article according to an embodiment of the disclosure;

FIG. 3D illustrates an example prompt for determining a relevance score for an article according to an embodiment of the disclosure;

FIG. 3E illustrates an example prompt for summarizing a newsletter according to an embodiment of the disclosure;

FIGS. 4A-4B illustrate an example newsletter template according to an embodiment of the disclosure;

FIGS. 5A-5B illustrate an example newsletter according to an embodiment of the disclosure;

FIG. 6 illustrates an example editor's view template according to an embodiment of the disclosure;

FIG. 7 illustrates an example editor's view newsletter using the editor's view template shown in FIG. 6 according to an embodiment of the disclosure;

FIGS. 8-10 illustrate example newsletters posted on example social media platforms according to embodiments of the disclosure;

FIG. 11 illustrates a diagram of an example data flow according to an embodiment of the disclosure;

FIG. 12 illustrates an example user interface for receiving recommendations and new recipients according to an embodiment of the disclosure;

FIG. 13 illustrates an example user interface for receiving edits according to an embodiment of the disclosure; and

FIG. 14 illustrates a block diagram of an example computing system according to an embodiment of the disclosure.

### DETAILED DESCRIPTION

Embodiments disclosed herein provide automated apparatuses, systems, and methods to gather articles, generate newsletters, and send the newsletters to recipients. The articles can be news stories that are located on websites or webpages, blogs, video hosting websites, social media sites, applications, magazines, and other news sources owned by Iterate.ai or third-party sources. The newsletters or content from the newsletters can be transmitted to recipients by email, text messages, instant messages, posted on social media sites, posted on blogs, posted as videos generated into video websites, posted on websites, or via another type of electronic communication system. The newsletters may include text, graphics, images, videos, audio, hyperlinks, announcements (e.g., advertisements), and the like. The newsletters can cover any number of topics for any possible subject and any possible industry. One advantage to this myriad of options is the ability to produce thousands of hyper-niche newsletter titles featuring almost any topic.

A newsletter may be transmitted to recipients on a regular publication schedule with limited human involvement or without any human involvement. One or more artificial intelligence (AI) tools can be used to generate the newsletter. The AI tool(s) can be a chatbot, a large language model (LLM), a small language model (SLM), an AI Agent, Agentic AI, machine learning, generative AI, natural language processing, other AI or AI-powered tools, and combinations thereof. The use of AI to generate the newsletters, a process that includes gathering, parsing, ranking, and sorting articles, creates a fully automated newsletter generation system, where zero human intervention is required. An infinite number of newsletters can be generated simultaneously and sent to an infinite number of recipients. The process involves the automated management of thousands of recipient identifiers (e.g., email addresses, mobile telephone numbers, and/or usernames) for thousands of newsletter deployments on varying publication schedules.

In some embodiments, a human sets up a title for the newsletter and/or creates one or more templates. In a non-limiting nonexclusive example, a template is created for a welcome email with human involvement. One or more templates for the newsletters may be created with human involvement or without human involvement. In one embodiment, one template is used for the newsletters. Other templates can be created with or without human involvement. Once the title for a newsletter is set up, the generation and transmission of the newsletter is automatic and performed without human intervention. In other embodiments, the newsletter can be edited by a human prior to transmission of the newsletter to the recipients. The human may be an editor or another person responsible for the newsletter.

Additionally, in some instances, a recipient or a user not currently receiving a newsletter can request one or more topics as a title for a new newsletter. The request can be received via email, text messaging, a web page or website, or by some other type of electronic communication. Once the request is received, and the title is set up, the generation and transmission of the newsletter may be automatic and performed without human intervention or with limited human intervention. As used herein, the terms “automatic” and automatically” mean without human intervention.

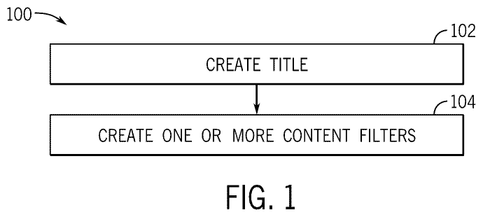

FIG. 1 illustrates a flowchart of an example method 100 of news curation according to an embodiment of the disclosure. The method 100 may be a set up process that is performed prior to the generation and transmission of a newsletter. In one embodiment, the method 100 is performed by a human, although other embodiments are not limited to this implementation. For example, the method 100 may be performed by an AI Agent in some embodiments. The method is described in conjunction with one newsletter, but the method can be performed for multiple newsletters.

At block 102, a title for the newsletter is created. The title can include one or more topics. A topic can be any subject or area of interest. Example topics include, but are not limited to, a technology, an industry, a company, a department/profession/role in a company, a location, and/or a special interest. Example topics for technology can be AI, AI for Big Chips, Cybersecurity, smartphones, and virtual reality. Example topics for industry may be Beauty, Retail, Industrial Manufacturing, Big Tech, and Healthcare. Example topics for companies can be APPLE, GOLDMAN SACHS, and JOHNSON & JOHNSON. Example topics for departments or professions in a company may be Human Resources, Accounting, and Chief Executive Officer. Example topics for locations can be a city, a state, a country, or a point of interest. Example topics for special interests may be Cancer, Weight Loss, a particular Social Cause, and Painting. In some instances, a topic can be included in more than one category. For example, Human Resources can be a department in a company and a profession or a role in a company. Other topics can be used in other embodiments. Non-limiting non-exclusive examples of titles include, but are not limited to, AI for Beauty, AI for Colorado, AI for Food and Beverage Manufacturing, Weight Loss and JOHNSON & JOHNSON, and Cancer, AI and Healthcare.

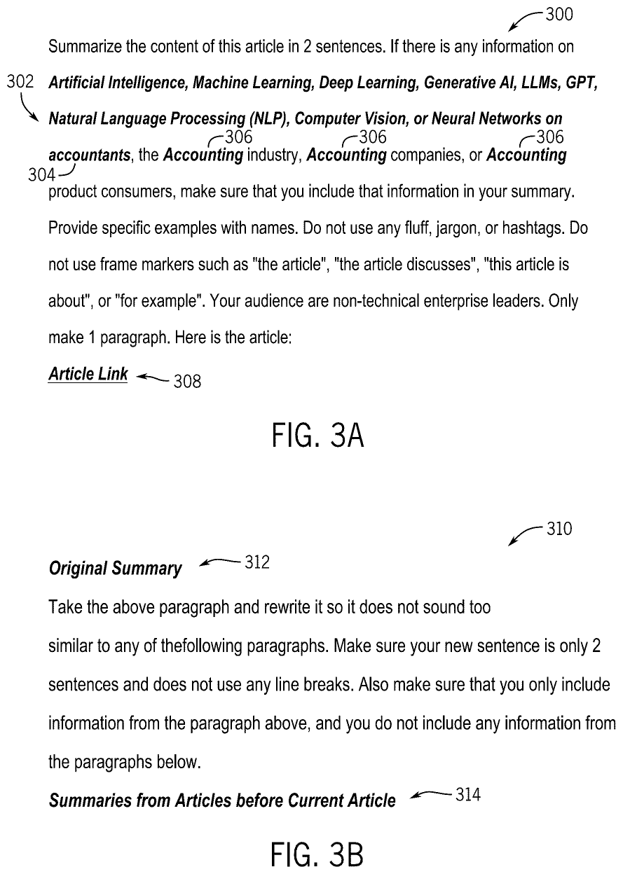

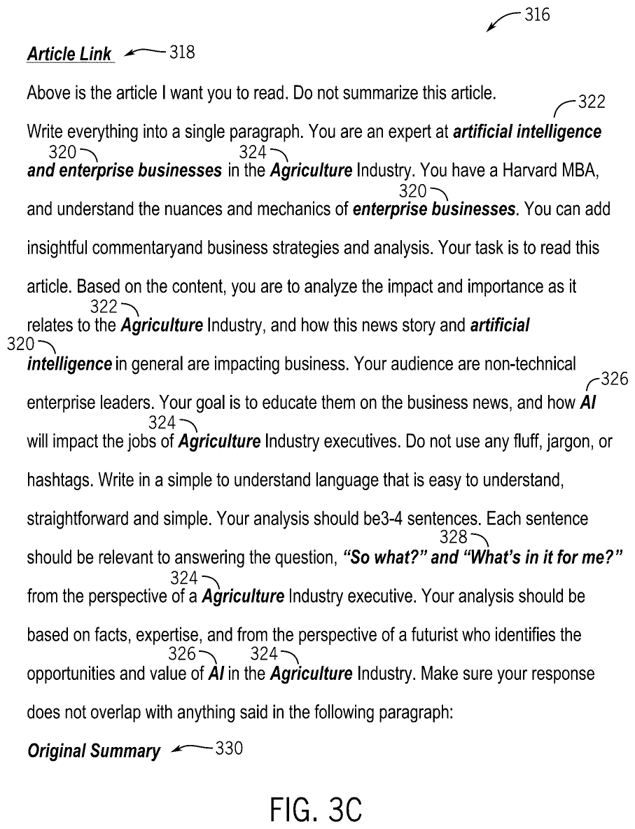

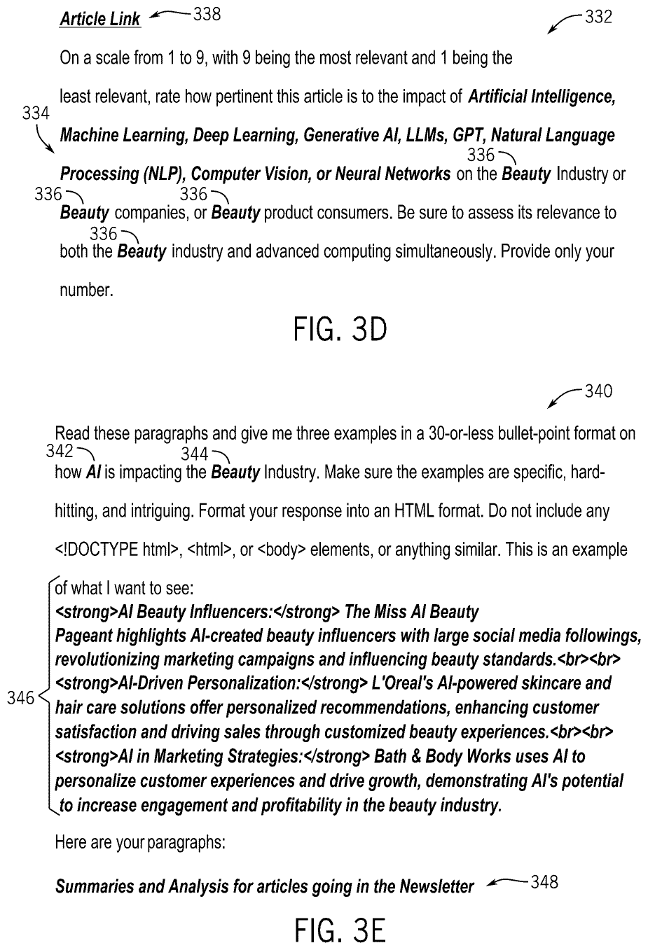

At block 104, one or more topic filters or prompts for each title are created. The prompts or topic filters can be used by one or more AI tools to automatically curate, analyze, summarize, and/or rank articles. As described earlier, an article may be any type of content, including, but not limited to, news stories, blog posts, videos, product communications, images or photos, websites or webpages, links (e.g., hyperlinks), and graphics. The topic filters and/or prompt(s) may be used with computational models, natural language processing models, LLMs, generative AI, and/or other AI tools. Non-limiting nonexclusive example prompts are described in more detail in conjunction with FIGS. 3A-3E. Block 104 may be omitted in embodiments where the topic filters or prompts are created automatically without human involvement.

Although FIG. 1 depicts the blocks in a particular order, the blocks may be performed in a different order in other embodiments. For example, block 104 can be performed before block 102.

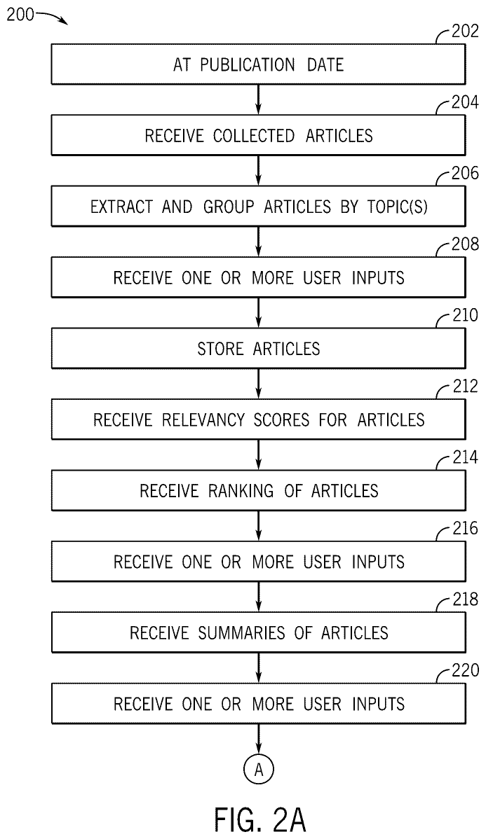

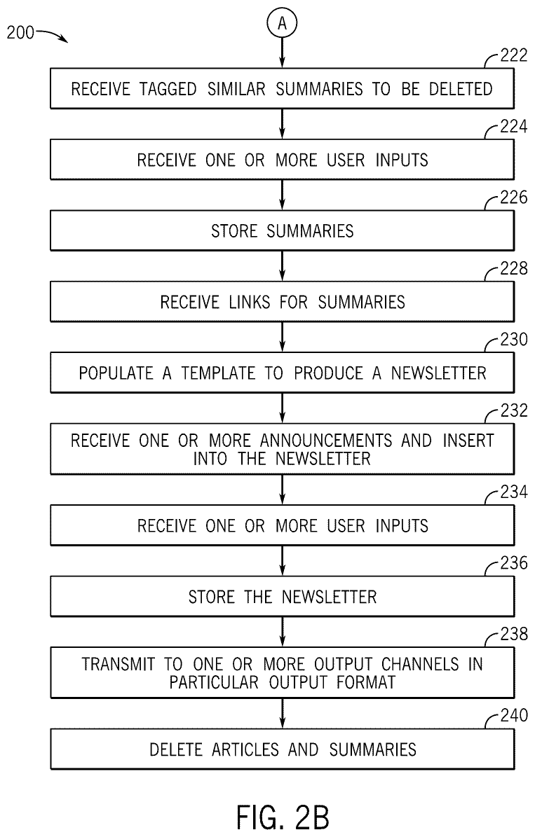

FIGS. 2A-2B illustrate a flowchart of an example method 200 of automated news curation according to an embodiment of the disclosure. The method 200 is described in conjunction with one newsletter, although the method 200 may be performed for multiple newsletters simultaneously or concurrently. The method 200 can be performed after the method 100 shown in FIG. 1 is completed.

At block 202, the method 200 begins at or near a publication date for the newsletter, such as on the day of or the day prior to the publication date. In some examples, near the publication date may be defined based on a frequency of publication of the newsletter. For example, where the newsletter is published weekly, near the publication date may be defined as a day or a few days prior to the publication date. Where the newsletter is published annually, near the publication date may be defined as a week or a month prior to the publication date. In some embodiments, the newsletter is generated prior to a publication date to allow for the newsletter to be edited (e.g., by a person managing the newsletter). The edited newsletter is then transmitted to recipients some time thereafter. For example, an editor version of the newsletter may be generated to allow a human to edit the newsletter. The newsletter (whether actually edited or not by the human) is transmitted to recipients forty-eight hours later. In other embodiments, the newsletter is automatically generated and transmitted to recipients (immediately after generation or sometime later).

At block 204, articles are collected using one or more prompts that are associated with the title of the newsletter. In one embodiment, one or more news aggregator applications and/or one or more AI tools are used to collect the articles. The one or more AI tools may be machine learning model(s), generative AI, natural language processing model(s), LLMs, other AI or AI-powered tools, and combinations thereof. In a non-limiting nonexclusive example, the application FEEDLY and one or more topic filters are used to collect the articles.

At block 206, articles are extracted from the collected articles and are grouped by a topic. For example, in some embodiments, a title can have multiple topics, and the collected articles may be related to one topic or to two or more topics. In one embodiment, the articles are grouped using one or more AI tools. In a non-limiting nonexclusive example, the application CHATGPT is used to group the articles by topic. A relevancy score may be used to group the articles by topic, where the AI tool(s) (e.g., CHATGPT) ranks the articles by the relevancy of each article to the title of a newsletter and/or the topic filter(s) or prompt(s) that were used to collect the articles.

At block 208, one or more user inputs regarding the grouped articles can be received. For example, an administrator, an editor, or another person managing a newsletter may edit the grouped articles. For example, the person can move an article from one topic to another, delete an article, or include an article that is currently listed in one group (under one topic) in another group such that the article is grouped under two topics.

At block 210, the articles are stored. In one embodiment, the articles are stored by topic in memory. For example, the articles may be stored in one or more databases or other applications, such as one or more spreadsheets. In one embodiment, the articles are stored using one or more AI tools. In a non-limiting nonexclusive example, the articles are stored by topic in GOOGLE SHEETS by MAKE.COM.

At block 212, a relevancy score is received for each collected article that is grouped under each particular topic. The relevancy score indicates how relevant the article is to the particular topic. In one embodiment, the relevancy scores are determined using one or more prompts that are associated with the topic or a title. One or more AI tools can be used to determine the relevancy scores. In a non-limiting nonexclusive example, the application CHATGPT and one or more prompts that provide instructions for determining the relevancy scores are used to collect the articles.

At block 214, a ranking of the articles is received. The articles may be ranked by group (e.g., by topic) based on the relevancy scores. In one embodiment, the articles are ranked using one or more AI tools. The relevancy scores may be determined by the one or more AI tools based on how relevant each article is to the title of the newsletter and/or the topic filters or prompts. In a non-limiting nonexclusive example, the application CHATGPT and one or more prompts that provide instructions for determining the ranking are used to rank the articles.

At block 216, one or more user inputs regarding the ranked articles can be received. An administrator, an editor, or another person managing a newsletter may edit the ranked articles. For example, the person can move an article from one ranking to another ranking or delete an article from the ranking.

At block 218, summaries of the articles are received. The summaries may be a paragraph in length, a given number of sentences (e.g., one or two sentences), bullet point summaries, other types of summaries, or combinations thereof. In some instances, such as when summarizing for an overview, multiple articles (e.g., the top N articles) can be summarized into paragraphs, a given number of sentences, bullet point summaries, other types of summaries, or combinations thereof. In one embodiment, the articles are summarized using one or more AI tools. In a non-limiting nonexclusive example, the application CHATGPT and one or more prompts that provide instructions for the summaries are used to summarize the articles.

In some embodiments, an analysis for the articles and/or the entire newsletter (once generated) may be provided. In one embodiment, the articles and/or the newsletter are analyzed using one or more AI tools. In a non-limiting nonexclusive example, the application CHATGPT and one or more prompts that provide instructions for the analysis are used to analyze the articles and/or the newsletter.

At block 220, one or more user inputs regarding the summaries may be received. For example, an administrator, an editor, or another person managing a newsletter may edit the summaries. For example, the person can condense a summary, rearrange the summary, or otherwise edit a summary.

At block 222, a list of similar summaries may be received with one or more of the similar summaries tagged for deletion. For example, multiple articles may be written in response to a world event. Each article may describe the world event and as such, some of the summaries of the articles can be similar, repetitive, or redundant. One or a limited number of the summaries may be used in a newsletter, and any additional summaries can be deleted. In one embodiment, the similar summaries are identified and deleted based on the relevancy score that was determined for the associated article. The one or more summaries may be identified and deleted using one or more AI tools. In a non-limiting nonexclusive example, the application MAKE.COM or CHATGPT is used to identify and delete similar summaries.

At block 224, one or more user inputs regarding the similar summaries may be received. For example, an administrator, an editor, or another person managing a newsletter may review a list of the similar summaries and tag a summary for deletion or remove a tag such that the summary is not deleted.

At block 226, the summaries are stored in a memory. The memory may be the same memory that stores the articles at block 210 or a separate memory. In one embodiment, the summaries are stored by group (i.e., topic) in the memory. For example, the summaries may be stored in one or more databases or other applications, such as one or more spreadsheets. In one embodiment, the summaries are stored using one or more AI tools. In a non-limiting nonexclusive example, the summaries are stored by topic in GOOGLE SHEETS by MAKE.COM.

At block 228, links to the source of the articles associated with the summaries are received. Each link can be a hyperlink that enables a recipient of the newsletter to select the link and be sent to the source of the article that is associated with the summary. The links may be attached to text, attached to an image or another element or presented adjacent a summary in the newsletter.

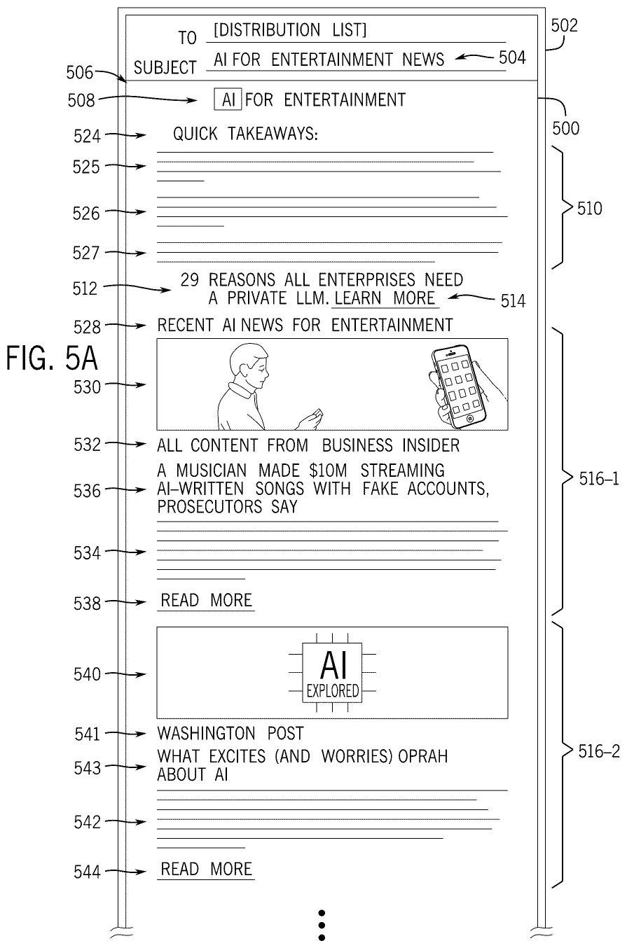

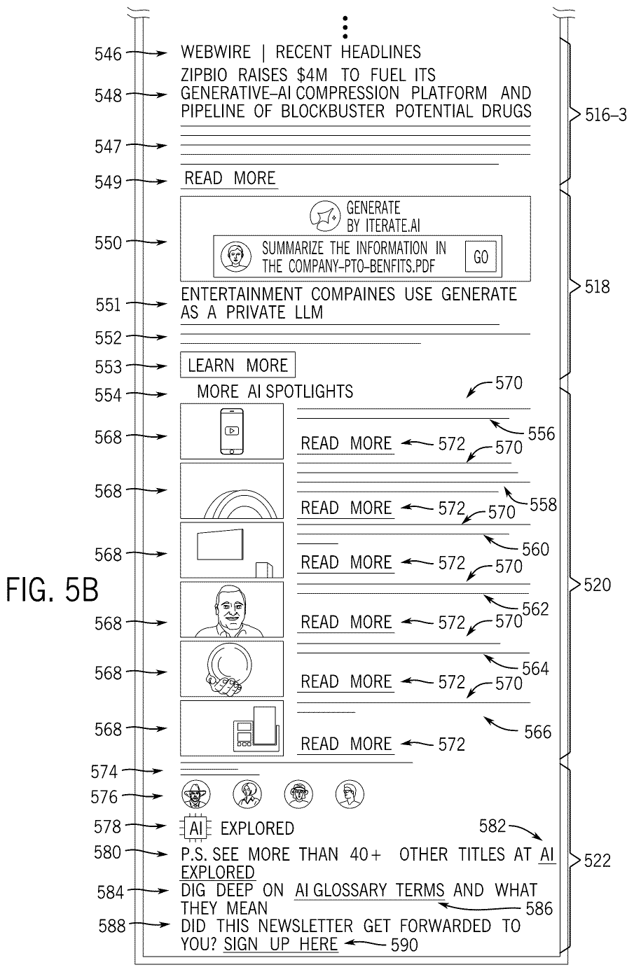

At block 230, a template is populated with content to produce one or more newsletters. The content can include, but is not limited to, the title (e.g., the title created at block 102 of FIG. 1), one or more summaries, one or more links, one or more images or graphics, and/or and other content. The number of summaries that are included in the newsletter may be limited to the top N summaries (N≥1), where the top N are determined based on the relevancy scores received at block 212. Additionally, the number of summaries that are included in the newsletter may be based on the output channel to be used to transmit the newsletter to the recipients. Example output channels include email, social media sites, blogs, text messaging, instant messaging, websites or webpages, and the like. For example, N may equal ten for email transmissions while N equals two for text messaging transmissions. In one embodiment, one or more AI tools are used to populate the template. In a non-limiting nonexclusive example, the template is populated with the content by SENDGRID. An example of a newsletter is described in more detail in conjunction with FIGS. 5A and 5B.

At block 232, one or more announcements are created and included in the newsletter. An announcement may be an advertisement, a notification, other types of statements, and/or general information such as contact information, additional links, and/or one or more images. In some embodiments, an announcement may be customized based on content in the newsletter. For example, an announcement can be customized based on the title, a topic, a subject, or an event in the newsletter. Additionally or alternatively, some or all of the advertisements may be advertisements paid for by third parties. In one embodiment, one or more AI tools are used to produce the announcement(s). In a non-limiting nonexclusive example, the announcement may be generated by CHATGPT and provided to SENDGRID for inclusion in the newsletter. In another non-limiting nonexclusive example, the announcement can be inserted into the template (e.g., at block 230).

At block 234, one or more user inputs regarding the newsletter may be received. For example, an administrator, an editor, or another person managing the newsletter may edit the newsletter. In one embodiment, an Editor's View of the newsletter is sent to a person to allow the person to edit the newsletter and/or confirm the newsletter (e.g., every column) is filled with the proper data type. In a non-limiting nonexclusive example, the editor platform AIRTABLE is used to edit the newsletter.

At block 236, the newsletter is stored in a memory. The memory may be the same memory that stores the articles at block 210, the memory that stores the summaries at block 224, or a separate memory. In one embodiment, one or more AI tools are used to store the newsletter in one or more databases. In a non-limiting nonexclusive example, the newsletter is stored by MAKE.COM.

At block 238, the newsletter is transmitted to an output channel in a particular output format. In one embodiment, one or more AI tools are used to transmit the newsletter to the output channel in the output format. As described earlier, the output channel may be email, one or more social media sites, text messaging, one or more blogs, instant messaging, a website or webpage, and other types of electronic communications. In a non-limiting nonexclusive example, the newsletter is transmitted to the recipients by SENDGRID.

In embodiments that provide an Editor's View of the newsletter at block 234, the newsletter (whether actually edited or not) may be sent to the recipients after a certain amount of time has passed since the Editor's View was provided. For example, the newsletter can be sent to the recipients after twenty-four or forty-eight hours have passed since provision of the Editor's View of the newsletter.

The output format can be text (written) or video (audio/visual). For video, a virtual voice may read some or all of the newsletter so that it sounds like a person talking on the video. Additionally or alternatively, a virtual person (e.g., face) with a virtual voice can read some or all of the newsletter so that it sounds and looks like a person talking on the video. In one embodiment, one or more AI tools are used to produce the video using the newsletter. In a non-limiting nonexclusive example, the AI video generator application HEYGEN is used to create a video.

At block 240, the articles and the summaries stored in the memory or memories are deleted after the newsletter has been sent to the recipients. In some embodiments, the articles and/or the summaries are deleted after a certain amount of time has passed since the newsletter was sent to the recipients. In other embodiments, the articles and/or the summaries are not deleted but rather are stored indefinitely.

Although FIGS. 2A-2B depicts certain blocks being performed in a particular order, the blocks may be performed in a different order, or some blocks may be omitted, in other embodiments. For example, blocks 208, 216, 220, 224, 234 can be omitted in embodiments that utilize an automatic news curation process. Additionally or alternatively, block 232 may be omitted or performed before block 230 such that the announcement(s) are included in the newsletter when the template is populated with the other content.

FIGS. 3A-3E illustrate example prompts according to an embodiment of the disclosure. The prompts can be provided to a summarizing platform that is or includes one or more AI tools. The prompts are text-based inputs (e.g., instructions) for the AI tool(s) that instructs the AI tool(s) to perform an action. The illustrated prompts are examples only and different prompts may be used in other embodiments.

FIG. 3A illustrates a prompt 300 that can be used to summarize an article to produce a summary. As stated in the prompt 300, the action is to summarize the content of an article in two sentences. The prompt 300 includes multiple topics, including technology topics 302, a profession topic 304, and an industry topic 306. The technology topics 302 are artificial intelligence, machine learning, deep learning, generative AI, LLMs, GPT, natural language processing (NLP), computer vision, or neural networks. The profession topic 304 is accountant, and the industry topic 306 is accounting. The prompt 300 also includes a link 308 to the article to enable the AI tool to access the article.

The prompt 300 can be different in other embodiments. For example, the technology topics 302, the profession topic 304, and/or the industry topic 306 can be different topics. The action that is described in the prompt 300 may be different. For example, the prompt 300 may instruct the AI tool to summarize the content of the article in six sentences. Additionally or alternatively, the defined audience may be different. Some of the instructions may be deleted, such as the restriction against using frame markers.

FIG. 3B illustrates an example prompt 310 for rewriting a summary of an article according to an embodiment of the disclosure. The prompt 310 includes an original summary 312 (or a link to the original summary) and one or more summaries associated with other articles 314 that are listed before the article associated with the summary to be rewritten. In one embodiment, the one or more summaries associated with articles that are listed before the article are based on the relevancy scores that were determined for each article.

The prompt 310 instructs the AI tool to rewrite the original summary 312 in a manner that results in the rewritten summary not sounding too similar to the other summaries 314. The prompt 310 includes further instructions, such as not using any line breaks and not including any information from the other summaries 314. The prompt 310 can be different in other embodiments.

FIG. 3C illustrates an example prompt 316 for analyzing an article according to an embodiment of the disclosure. The prompt 316 includes a link 318 to the article, a business topic 320 (enterprise business), a technology topic 322 (artificial intelligence), an industry topic 324 (agriculture), a technology topic 326 (AI), questions 328 that are relevant to the analysis, and the original summary 330 of the article. The prompt instructs an AI tool to write a single paragraph and provides parameters for the AI tool. The parameters may determine the behavior of the AI tool and control the AI tool's response to the prompt. The parameters include, but are not limited to, a Harvard MBA, understanding the nuances and mechanics of the business topic, and adding insightful commentary and business strategies and analysis. The AI tool is instructed to analyze the impact and importance of the content in the article as it relates to the industry topic. The prompt 316 also provides a description of the audience for the analysis (non-technical enterprise leaders) and a perspective for the analysis (a futurist who identifies the opportunities and value of the technology and industry topics. The prompt 316 can be different in other embodiments.

FIG. 3D illustrates an example prompt 332 for determining a relevance score for an article according to an embodiment of the disclosure. The prompt 332 includes technology topics 334 and an industry topic 336. The technology topics 334 are artificial intelligence, machine learning, deep learning, generative AI, LLMs, GPT, natural language processing (NLP), computer vision, or neural networks. The industry topic 336 is Beauty. The prompt 332 also includes a link 338 to the article to enable the AI tool to access the article.

The prompt instructs the AI tool to rate how pertinent the article is the impact of the technology topics 334 on the industry 336 and to provide only a number as an output. The prompt further includes parameters such as a scale from one to nine with nine being the most relevant and one the least relevant. The prompt 332 can be different in other embodiments.

FIG. 3E illustrates an example prompt 340 for summarizing a newsletter according to an embodiment of the disclosure. The prompt 340 includes a technology topic 342, an industry topic 344, and an example output 346. The prompt 340 further includes summaries and analysis for articles 348 that will be in the newsletter. The prompt 332 can be different in other embodiments.

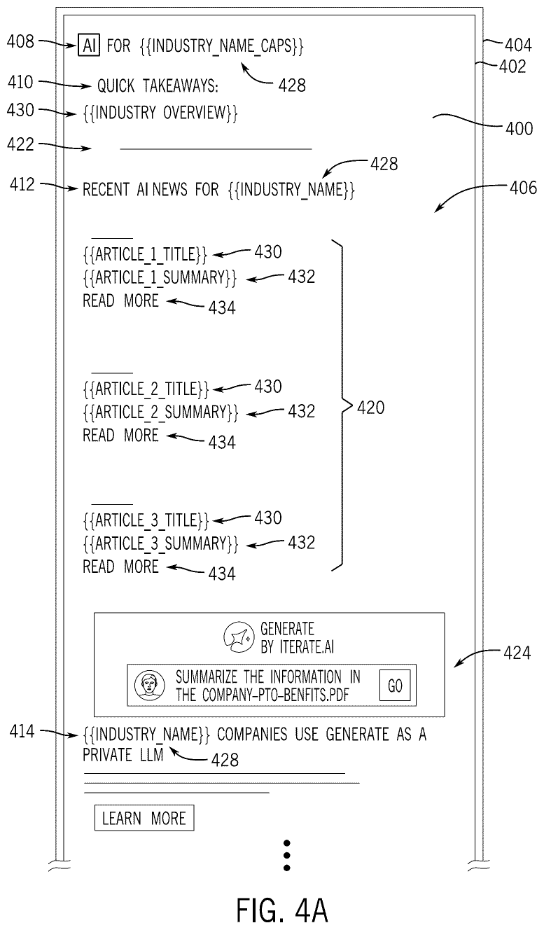

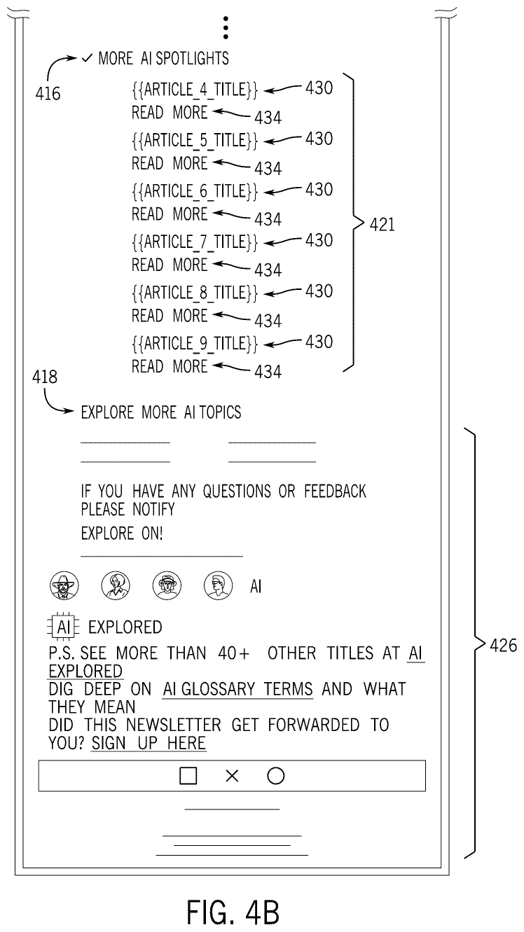

FIGS. 4A-4B illustrate an example newsletter template 400 according to an embodiment of the disclosure. The newsletter template 400 is shown displayed in a user interface 402 on a display screen 404 of a display device. The user interface 402 may be configured to allow a user to create and edit the newsletter template using, for example, visual drag and drop editing or code editing, such as HTML, CSS, and/or JAVA.

The newsletter template 400 includes a content section 406 that will be used to populate the newsletter template 400 with content such as summaries of articles, announcements, images, a title, and other content to produce a newsletter. Elements in the content section 406 may include a title 408, headers 410, 412, 414, 416, 418, placeholders 420, 421 where one or more summaries of articles will be inserted, announcements 422, 424, and general information 426. In one embodiment, the headers 410, 416, 418 are static and do not change based on other information, and the title 408 and the headers 412, 414 are dynamic or variable in that the title 408 and the headers 412, 414 include placeholders 428 where additional information is inserted. In the illustrated embodiment, the additional information includes an industry name.

Each placeholder 420 includes an article title placeholder 430, an article summary placeholder 432, and a link placeholder 434 for a link (e.g., a hyperlink). Each placeholder 421 includes the article title placeholder 430 and the link placeholder 434. Each article title placeholder 430, article summary placeholder 432, and link placeholder 434 are populated with a title, an article summary and a link (e.g., a hyperlink) respectively, when a newsletter is generated.

The header 410 (i.e., quick takeaways) includes a placeholder 430 for an industry overview. The industry overview may include information on new or emerging trends that are associated with the title 408, a summary of the top developments associated with the title 408, and other interesting or important news. Each summary inserted into the placeholders 420 can be a summary associated with the top N articles as ranked in block 214 of FIG. 2A. The announcements 422, 424 are advertisements in the illustrated embodiment, with a static announcement 422 and a dynamic announcement 424 (based on placeholder 428). The general information 426 can include information on the editors/managers of the newsletter, other types of titles and newsletters the recipient can subscribe to, and other types of general information that is associated with the newsletter and/or the title.

FIGS. 5A-5B illustrate an example email newsletter 500 according to an embodiment of the disclosure. The email newsletter 500 is shown displayed on a display screen 502 of a display device. The subject 504 of the illustrated email newsletter 500 is AI for Entertainment news, and the content 506 of the email newsletter 500 relates to the use of AI in the entertainment industry. The content 506 includes a title 508, a takeaway section 510, an announcement 512, summaries 516-1, 516-2, 516-3, an announcement 518, an additional points of interest section 520, and a general information section 522.

The takeaway section 510 includes a header 524 (“Quick Takeaways”) and points of interest 525, 526, 527. Each point of interest 525, 526, 527 provides a statement about developing or new uses of AI in the entertainment industry. In the illustrated example, the points of interest 525, 526, 527 are one-sentence statements, although other embodiments are not limited to this implementation.

The announcement 512 is an advertisement that provides a link 514 to enable a recipient to access more information on the subject matter in the advertisement (“29 reasons all enterprises need a private LLM”). A header 528 (“Recent AI News for Entertainment”) is provided above the summary 516-1. The summary 516-1 includes an image 530, a listing 532 of the source of the article that was used to produce a summary 534 of the article, a header 536, and a link 538 that, when selected, connects to the article at the source identified in the listing 532 (e.g., a hyperlink). The summary 516-2 includes an image 540, a listing 541 of the source of the article that was used to produce the summary 542, a header 543, and a link 544 that, when selected, connects to the article at the source identified in the listing 541. The summary 516-3 includes a listing 546 of the source of an article that was used to produce a summary 547 of the article, a header 548, and a link 549 that, when selected, connects to the article at the source identified in the listing 546. In some embodiments, a substitute image can be presented when an image for a summary is not available. For example, the image 540 may be a substitute image.

The announcement 518 includes a graphic 550, a header 551, a statement 552, and a button 553. The button 553 functions as a link to a web page, website, or other source that provides more information on the content of the announcement 518. For example, as shown in FIG. 5B, the announcement 518 is an advertisement for a product “Generate” by the company Iterate. ai, and the button 553, when selected, directs the recipient to a webpage that provides more information on the product and/or the company.

The additional points of interest section 520 includes one or more highlights on the title. For example, in FIG. 5B, the additional points of interest section 520 includes highlights 556, 558, 560, 562, 564, 566. Each highlight 556, 558, 560, 562, 564, 566 includes an image or a graphic 568, a statement 570, and a link 572 that when selected, directs the recipient to more information on the subject matter of the highlight 556, 558, 560, 562, 564, 566.

The general information section 522 can include any general information about the title 508, the newsletter 500, the provider of the newsletter, the editor(s) and/or otherwise responsible entities (e.g., humans, website, application, and the like), information related to the title 508 and/or a topic in the title 508 (e.g., AI and/or Entertainment), other newsletter the recipient can subscribe to, and other general information. In FIG. 5B, the general information section 522 includes an introduction 574, one or more images or graphics 576 of persons to contact, a graphic 578 that identifies the provider of the newsletter, a statement regarding other newsletter and a link 582 to information on the other newsletter, a statement 584 and a link 586 associated with a glossary of terms associated with the title and/or a topic (e.g., AI), and a statement 588 and a link 590 enabling the recipient to sign up for the newsletter. The general information section 522 may include different information in other embodiments.

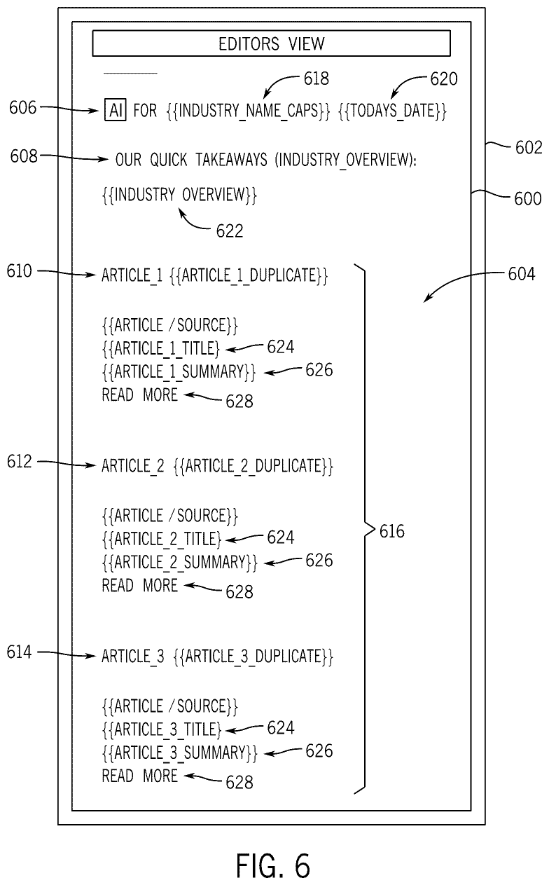

FIG. 6 illustrates an example editor's view template 600 according to an embodiment of the disclosure. The editor's view template 600 is shown displayed on a display screen 602 of a display device. The editor's view template 600 includes a content section 604 that will be populated with content such as summaries of articles, a title, and other content to produce an editor's view newsletter. Elements in the content section 604 may include a title 606, headers 608, 610, 612, 614, and placeholders 616 where summaries of articles will be inserted. In one embodiment, the title 606 and the header 608 are dynamic or variable in that the title 606 and the header 608 include placeholders 618, 620, 622 where additional information is inserted. In the illustrated embodiment, the additional information includes an industry name, a date, and an industry overview, respectively. Each placeholder 616 includes an article title placeholder 624, an article summary placeholder 626, and a link placeholder 628. Each article title placeholder 624, article summary placeholder 626 and link placeholder 628 are populated with a title, an article summary and a link, respectively, when the editor's view newsletter is generated.

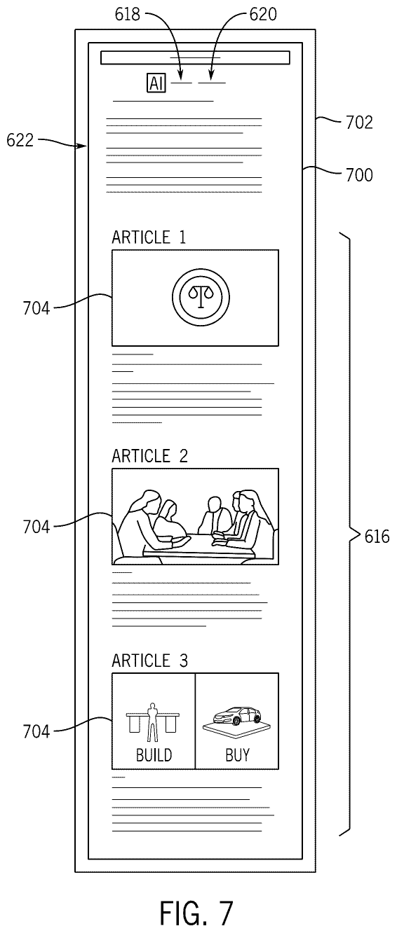

FIG. 7 illustrates an example editor's view newsletter 700 using the editor's view template 600 shown in FIG. 6 according to an embodiment of the disclosure. The editor's view newsletter 700 is shown displayed on a display screen 702 of a display device. As shown, the placeholders 616, 618, 620, 622 have been populated with content to produce the editor's view newsletter 700.

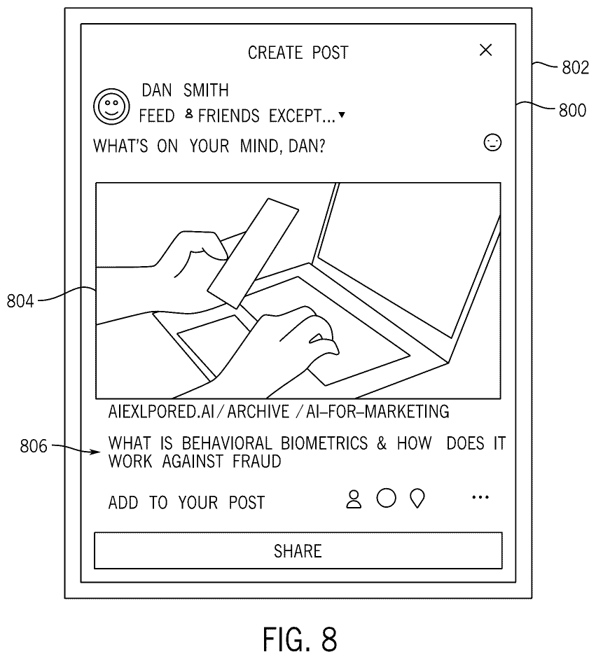

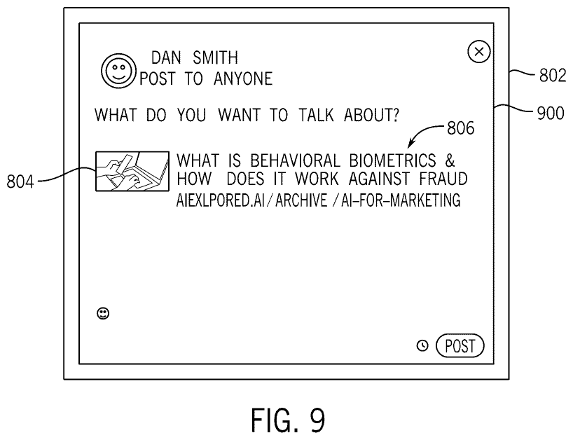

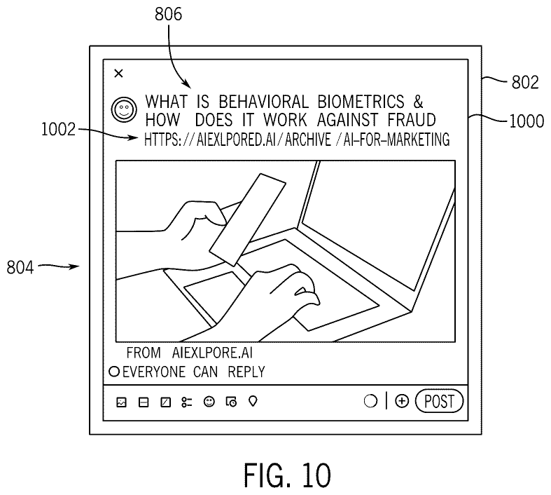

FIGS. 8-10 illustrate example newsletters 800, 900, 1000 posted on example social media platforms according to embodiments of the disclosure. The newsletters 800, 900, 1000 are shown displayed on display screens 802 of a display device. FIG. 8 depicts a newsletter 800 that includes an image 804 and a title 806. The image 804 and/or the title 806 may function as a link such that when the image 804 or the title 806 is selected, an article and/or a summary associated with the title 806 is displayed. FIG. 9 depicts a newsletter 900 that includes the image 804 and the title 806. Similarly, FIG. 10 depicts a newsletter 1000 that includes the image 804 and a title 806. The newsletter 1000 also includes a link 1002 that causes more information to be displayed when selected. For example, the link 1002 can cause the newsletter associated with the title 806 to be displayed. Although the example newsletters 800, 900, 1000 present particular content, other embodiments are not limited to these implementations. A newsletter that is posted to a social media platform can include other content, such as multiple images and/or titles, announcements, overviews, and other content.

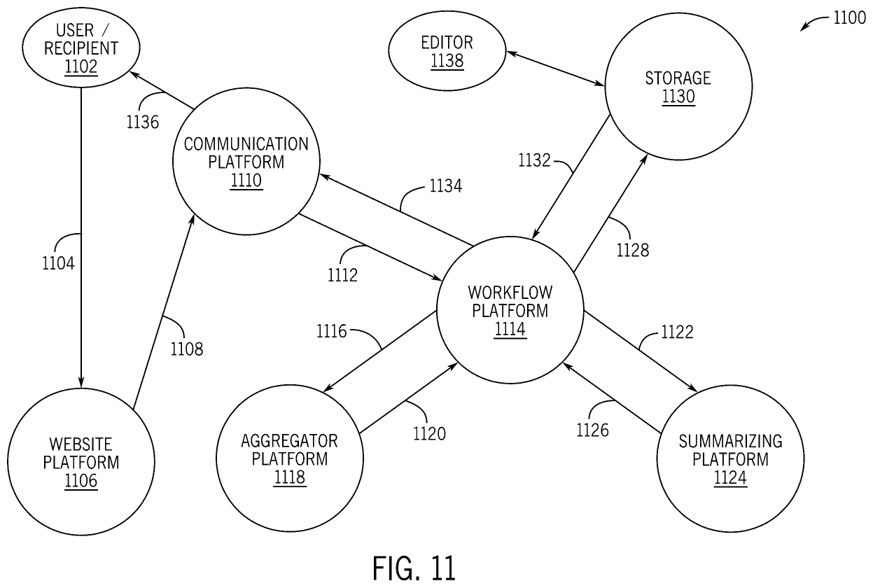

FIG. 11 illustrates a diagram of an example data flow 1100 according to an embodiment of the disclosure. The data flow 1100 begins with a user/recipient device 1102 transmitting a request 1104 to receive one or more newsletters to a website platform 1106. The request 1104 includes contact information and one or more topics that interest the user/recipient. The contact information can be an identifier that allows the user/recipient to receive newsletters. Example identifiers include, but are not limited to, an email address, a mobile telephone number, personal information such as a name or a geographical location, and a username or a handle of a social media site. The website platform 1106 may include, but is not limited to, a website, a social media page, an application, or an organization that can receive text messages (e.g., using a business text number, an SMS inbox, or a short code and keywords). In a non-limiting nonexclusive example, the website platform 1110 is a website created using WEBFLOW.

The website platform 1106 transmits a message 1108 to a newsletter platform 1110. The message 1108 includes some or all of the information in the request 1104 (e.g., the contact information of the user/recipient, the one or more topics) and instructs the newsletter platform 1110 to create a welcome communication (e.g., a welcome newsletter) and transmit the welcome communication to the user/recipient device 1102. In a non-limiting nonexclusive example, the communication platform 1110 is an email delivery platform, such as SENDGRID. In other embodiments, the communication platform may be a text message delivery platform, a video delivery platform, a social media publishing platform (e.g., BUFFER), or another electronic communication delivery platform.

The communication platform 1110 transmits a message 1112 to a workflow platform 1114. The message 1112 can include some or all of the information in the request 1104 (e.g., the contact information of the user/recipient, the one or more topics). The workflow platform 1114 transmits a message 1116 to an aggregator platform 1118 that includes the one or more topics. The aggregator platform 1118 collects or aggregates articles based on the one or more topics that were received in the message 1116 by the aggregator platform 1118. The aggregator platform 1118 transmits a message 1120 to the workflow platform 1114. The message 1120 includes the collected articles. In non-limiting nonexclusive examples, the workflow platform 1114 is MAKE. COM and the aggregator platform 1118 is FEEDLY, and that both the title and the one or more FEEDLY topics are imputed into FEEDLY.

The workflow platform 1114 transmits a message 1122 to a summarizing platform 1124. The message 1122 includes the collected articles and an instruction to summarize the collected articles, determine relevancy scores for the articles, and rank the articles. The summarizing platform 1124 summarizes the collected articles to produce summaries of the collected articles, generates a relevancy score for each article or summary, and ranks the articles or summaries based on the relevancy scores.

The summarizing platform 1124 transmits a message 1126 to the workflow platform 1114. The message 1126 includes the articles, the summaries, the relevancy scores, and the ranking of the articles. Additionally, in some embodiments, the summarizing platform 1124 can include automated prompt generation for creating prompts and/or automated topic generation for creating topic filters. In a non-limiting nonexclusive example, the summarizing platform 1124 is CHATGPT.

The workflow platform 1114 transmits a message 1128 to storage 1130. The message 1128 includes the articles, the summaries, the relevancy scores, and the ranking(s) and an instruction to store the articles, the summaries, the relevancy scores, and the ranking in the storage 1130. The storage 1130 may be one or more memories and the articles, the summaries, the relevancy scores, and the ranking(s) can be stored in one or more databases or applications (e.g., GOOGLE SHEETS). The storage 1130 may store the articles and the summaries together by topic, or the articles can be stored by topic and the summaries stored separately by topic.

The storage 1130 transmits a message 1132 to the workflow platform 1114 when a newsletter is to be produced (e.g., at or near a publication date). The message 1132 includes the summaries, the relevancy scores, and the rankings associated with the summaries for one or more topics to be included in the newsletter. The workflow platform 1114 may package the summaries, the relevancy scores, and the rankings as structured data in a standardized format and transmit the structured data and a distribution list (e.g., recipient contact information) in a message 1134 to the communication platform 1110. The communication platform 1110 deletes any similar summaries and populates a template associated with the newsletter with content (e.g., some or all of the summaries, any announcements, etc.) to produce the newsletter. The communication platform 1110 transmits the newsletter 1136 to the recipients.

In some embodiments, an editor device 1138 is included in the data flow 1100. The editor device 1138 may be used by an administrator, an editor, or another person responsible for the newsletter to provide user inputs and one or more operations in the data flow 1100. For example, user inputs may be received from the editor device 1138 to edit a list of articles that have been grouped by topic, to edit a ranking of the articles, to edit one or more summaries of the articles, to edit a list of similar summaries with at least one summary in the list tagged for deletion, and/or to review or edit an Editor's View of a draft of a newsletter. In one embodiment, user inputs may be received from the editor device 1138 at one or more of the blocks 208, 216, 220, 224, or 234 shown in FIGS. 2A-2B.

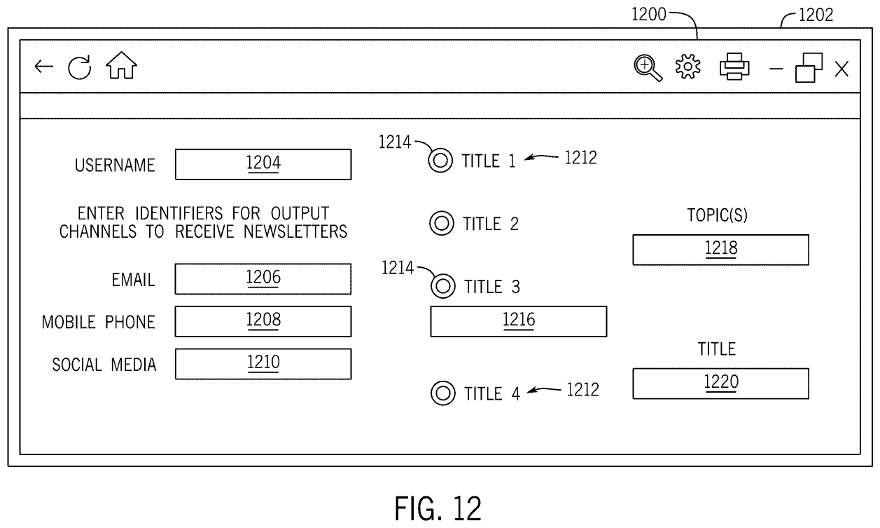

FIG. 12 illustrates an example user interface 1200 for receiving recommendations and new recipients according to an embodiment of the disclosure. The user interface 1200 is shown as displayed on a display screen 1202 of a display device. In one embodiment, the user interface 1200 is displayed in response to a recipient or user wanting to receive one or more newsletters (e.g., message 1104 in FIG. 11) and/or suggest one or more topics and/or a title for a new newsletter.

The user interface 1200 can include a number of input elements that are configured to receive user inputs. Input element 1204 is configured to receive a username of the user/recipient. The username may be any type of username, including an email address, a name, or an alias. Input elements 1206, 1208, 1210 are configured to receive identifiers for receiving the newsletter(s). As shown, the identifiers can be an email address 1206, a mobile telephone number 1208, and a username of a social media site 1210.

The user or recipient can select one or more titles 1212 that are associated with newsletters using input elements 1214. The newsletter(s) associated with the selected titles 1212 will be sent to one or more of the identifiers 1206, 1208, 1210. In some embodiments, a user/recipient can specify which output channel should receive the selected newsletter 1212 using input element 1216.

The user interface 1200 is also configured to receive suggestions for topics and/or titles for existing or new newsletters. The user/recipient can enter one or more topics in the input element 1218 and/or a suggestion for a title in the input element 1220. In one embodiment, the entered topic(s) or title function as search queries to determine whether a newsletter is currently produced for that topic or title. Additionally or alternatively, the entered topic(s) or title are submitted as suggestions for new newsletters.

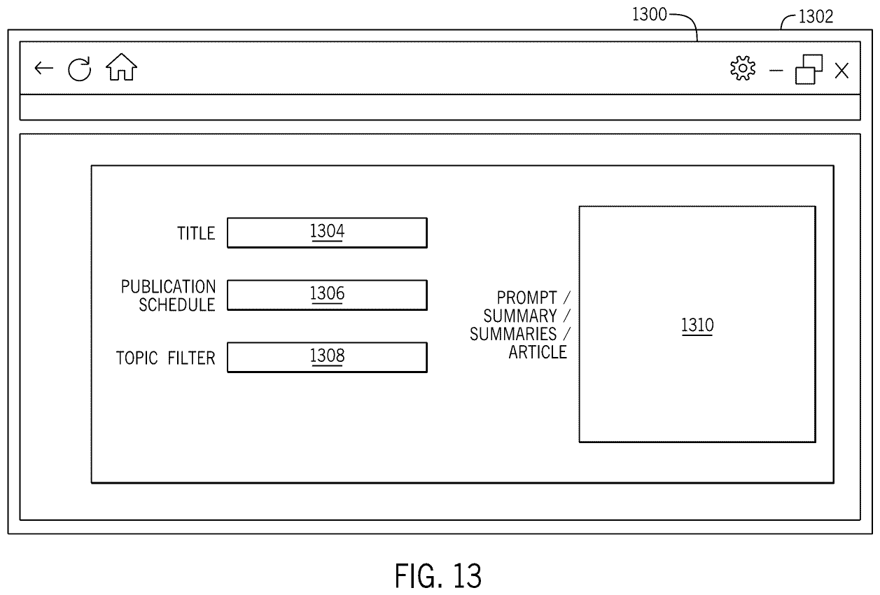

FIG. 13 illustrates an example user interface 1300 for receiving edits according to an embodiment of the disclosure. The user interface 1300 is shown as displayed on a display screen 1302 of a display device. The user interface 1300 is configured to display one or more content items to be edited. In other embodiments, edits may be performed in a user interface of one or more applications, such as in a user interface for GOOGLE SHEETS.

In the illustrated embodiment, the user interface 1300 is configured to edit a title of a newsletter via the input element 1304, a publication schedule for a newsletter using the input element 1306, and topic filters via the input element 1308. The input elements 1304, 1306, 1308 can be any suitable type of input element, such as text boxes. The current title, publication schedule, and topic filter(s) may be displayed and edited in the input elements 1304, 1306, 1308.

The publication schedule determines the time periods for the publication of a newsletter. A time period can be daily, weekly, every first Monday of a month, quarterly, a particular day of a month (e.g., the 15^{th}), or based on one or more criteria. The one or more criteria may be a minimum number of articles has been collected, the number of collected articles equally or exceeding a threshold, and/or the number of articles collected since the publication of the last newsletter equally or exceeding a threshold.

The publication schedule may be determined by a human or by one or more AI tools. In a non-limiting nonexclusive example, FEEDLY can collect articles daily or on another schedule and cause a newsletter to be generated and published using the one or more criteria.

Other information, such as prompts, article summaries, and articles can be viewed and editing using the input element 1310. An administrator, an editor, or another person managing a newsletter may edit the article summaries. For example, the person can condense a summary, rearrange the summary, or otherwise edit a summary (e.g., rewrite a portion of the summary or delete existing summary and write a new summary). Additionally or alternatively, a list of similar summaries may be listed in the document, and an administrator, an editor, or another person managing a newsletter may edit the list. For example, an administrator, an editor, or another person managing a newsletter may identify or tag a summary for deletion or remove a tag such that the summary is not deleted.

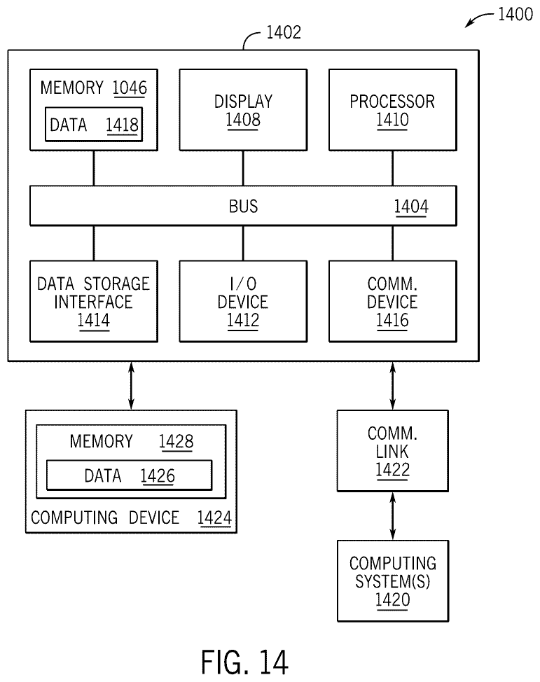

The systems, methods, and user interfaces disclosed herein may be implemented using various computing systems. FIG. 14 illustrates a block diagram of an example computing system for implementing various embodiments in the examples described herein. For example, the user/recipient device 1102, the website platform 1106, the communication platform 1110, the aggregator platform 1118, the workflow platform 1114, the summarizing platform 1124, the storage 1130, and/or the editor device 1138 shown in FIG. 11 may be implemented as, include, or within the computing system 1400. This disclosure contemplates any suitable number of computing systems 1400. For example, the computing system 1400 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 1400 may include one or more computing systems; be unitary or distributed; span multiple locations; span multiple locations; span multiple machines; span multiple data centers; or reside in a cloud, which may include one or more cloud components in one or more networks.

Computing system 1400 includes a first computing device 1402 that includes one or more communication structures, such as a bus 1404 (e.g., an address bus and a data bus) or other communication mechanism for communicating information, which interconnects subsystems and devices, such as memory 1406, a display 1408, a processor 1410, an input/output (I/O) device 1412, a data storage interface 1414, and a communications device 1416. Although only one of each component is shown in FIG. 14, other embodiments can include one or more of the bus 1404, the memory 1406, the display 1408, the processor 1410, the input/output device 1412, the data storage interface 1414, and/or the communications device 1416.

The memory 1406 is configured to store information, such as data and software applications (collectively data 1418). In one embodiment, the data 1418 can include one or more databases and processor-executable instructions for one or more software applications. For example, the data 1418 can include articles, summaries, rankings, announcements, images, graphics, templates, prompts, newsletters, recipient contact information, applications such as spreadsheets and email, and/or processor-executable instructions for creating user interfaces. The data 1418 can include different or additional data in other embodiments. The memory 1406 may be implemented as one or more types of volatile and non-volatile memory. For example, the memory 1406 can be a read only memory (ROM), dynamic and/or static random-access memory (RAM), flash memory, cache memory, erasable programmable ROM (EPROM), electrically erasable programmable ROM (EEPROM), virtual memory, optical memory, magnetic memory, and combinations thereof.

In particular embodiments, the processor 1410 includes hardware for executing processor-executable instructions, such as the instructions in a software application. The processor 1410 includes circuitry for performing various processing functions, such as executing specific software for performing specific calculations or tasks. For example, the processor 1410 may be implemented as a microprocessor, a central processing unit, a graphics processing unit, a neural processing unit, a digital signal processor, or combinations thereof.

The bus 1404 can include one or more memory buses (which may each include an address bus and a data bus) that couple the processor 1410 to the memory 1406. In particular embodiments, one or more memory management units (MMUs) reside between the processor 1410 and the memory 1406 and facilitate accesses to the memory 1406 as requested by the processor 1410. In particular embodiments, the bus 1404 includes hardware, software, or both coupling components of the computing device 1402 to each other.

The display 1408 includes circuitry and a display screen and is configured to present information on the display screen. For example, the display 1408 may be used to display, create, and/or edit prompts, templates, newsletters, websites or webpages, recipient contact information, documents to be edited, and other information. For example, the prompts 300, 310, 316, 332, 340 shown in FIGS. 3A-3E, the template 400 shown in FIGS. 4A-4B, the newsletter 500 shown in FIGS. 5A-5B, the editor's view template 600 and the editor's view newsletter 700 shown in FIGS. 6-7, the social media posts 800, 900, 1000 shown in FIGS. 8-10, and the user interfaces 1200, 1300 shown in FIGS. 12-13 can be displayed, created, and/or edited using the display 1408.

In particular embodiments, the I/O device 1412 includes hardware, software, or both, providing one or more interfaces for S between the I/O device 1412 and other components within the computing device 1402 and/or external to the computing device 1402. One or more of the I/O devices 1412 may enable communication between a user and the computing device 1402. The I/O device 1412 can include, but is not limited to, a keyboard, a keypad, a mouse, a microphone, speakers, input buttons, and combinations thereof. In some embodiments, the display 1408 may also function as an I/O device when the display 1408 is implemented as a touchscreen display that is configured to receive touch and/or force inputs as well as display information.

In particular embodiments, the communications device 1416 includes hardware, software, or both providing one or more interfaces for communication (such as, for example, packet-based communication) between the computing device 1402 and one or more computing systems 1420 and/or one or more other computer devices 1424. Example communications devices 1416 include, but are not limited to, a modem, an Ethernet card, a network interface controller (NIC) or network adapter for communicating with an Ethernet or other wire-based network, a wireless NIC (WNIC) or wireless adapter for communicating with a wireless network, such as a WI-FI network, and combinations thereof.

According to particular embodiments, the computing device 1402 performs specific operations by the processor 1410 executing one or more sequences of one or more processor-executable instructions stored in the memory 1406. For example, processor-executable instructions for one or more of the UIs, for accessing one or more databases, for one or more software applications, for displaying templates, prompts, newsletters, and the like, for displaying user interfaces, websites, and/or one or more of the methods described herein may be stored in the memory 1406 and may be executed by the processor 1410. Such processor-executable instructions may be read into the memory 1406 from another computer readable/usable medium, such as removable computer readable/usable medium (e.g., memory sticks, external hard drives). In alternative embodiments, hard-wired circuitry may be used in place of or in combination with processor-executable instructions. Thus, particular embodiments are not limited to any specific combination of hardware circuitry and/or software. In various embodiments, the term “logic” means any combination of software or hardware that is used to implement all, or part of particular embodiments disclosed herein.

The term “computer readable medium” or “computer usable medium” as used herein refers to any medium that participates in providing instructions to processor 1410 for execution. Such a medium may take many forms, including but not limited to, nonvolatile media and volatile media.

The computing device 1402 may transmit and receive newsletters, data, and instructions, including software applications (or processor-executable instructions) through a communications link 1422 and the communications device 1416. Received processor-executable instructions may be executed by the processor 1410 as it is received, and/or stored in the memory 1406 for later execution. In various examples, the communications link 1422 may be configured as a network to enable the computing device 1402 to communicate with, for example, a user device and/or a website platform (e.g., the user/recipient device 1102 and the website platform 1106 of FIG. 11). Non-limiting nonexclusive examples of networks include, but are not limited to, a wide area network, the Internet, a wireless network (e.g., a cellular network), an enterprise network, a cloud network, and combinations thereof.

The computing system 1400 may further include a computing device 1424 that stores data 1426 in memory 1428. In one embodiment, the data 1426 may include articles, summaries, rankings, announcements, images, graphics, templates, prompts, newsletters, recipient contact information, applications such as spreadsheets and email, and/or processor-executable instructions for creating user interfaces. The data 1418 can include different or additional data in other embodiments. The computing device 1402 and the computing device 1424 can communicate using the communications device 1416 or through a data storage interface 1414. The memory 1428 may be implemented similar to the memory 1406, and the computer device 1424 can be implemented similar to the computing device 1402. As such, the memory 1428 and the computing device 1424 are not described in detail.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of as defined in the claims. Although various embodiments have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements as defined in the following claims.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

The foregoing description, for purposes of explanation, uses specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A computer-implemented method for automated newsletter generation, comprising:
identifying, via a processor, based on a title of a newsletter, a plurality of articles that are associated with a topic, at or near a publication date of the newsletter;
generating, via the processor, a ranking of the plurality of articles based on relevancy scores associated with each article in the plurality of articles that indicate how relevant each article is to the topic, wherein the ranking of the plurality of articles utilizes a first prompt for a platform that comprises an artificial intelligence tool;
generating, via the processor, a plurality of summaries of the plurality of articles, wherein each summary of the plurality of summaries is for one of the plurality of articles, and wherein the generating of the plurality of summaries utilizes a second prompt for the platform;
generating, via the processor, the newsletter by populating a newsletter template associated with the newsletter with content to produce the newsletter, wherein the content comprises at least a portion of the plurality of summaries of the plurality of articles, wherein the at least the portion of the plurality of summaries of the plurality of articles is based on the ranking of the plurality of articles; and
transmitting, via the processor, the newsletter to an output channel to be received by a plurality of recipients.

2. The method of claim 1, further comprising receiving a request to receive the newsletter from each of the plurality of recipients.

3. The method of claim 1, further comprising receiving one or more edits to the newsletter prior to transmitting the newsletter to the output channel.

4. The method of claim 1, further comprising:
receiving, from an editor device, a user input to the ranking prior to generating the plurality of summaries of the plurality of articles; and
modifying the ranking based on the user input.

5. The method of claim 1, further comprising:
receiving, from an editor device, a user input to a summary of the plurality of summaries of the plurality of articles prior to generating the newsletter; and
modifying the summary based on the user input.

6. The method of claim 1, further comprising deleting a first summary in the plurality of summaries of the plurality of articles based on a similarity of the first summary to a second summary in the plurality of summaries of the plurality of articles.

7. The method of claim 1, further comprising:
receiving, from an editor device, a user input to the newsletter prior to automatically transmitting the newsletter to the output channel; and
modifying the newsletter based on the user input.

8. The method of claim 1, wherein the content further comprises an announcement.

9. The method of claim 8, wherein the announcement comprises an advertisement that is related to the topic.

10. The method of claim 1, wherein identifying the plurality of articles associated with the topic comprises:
utilizing the platform to determine the topic based on the title of the newsletter; and
utilizing the platform to identify the plurality of articles based on the topic.

11. The method of claim 1, further comprising generating the first prompt based on a first prompt template and the topic.

12. The method of claim 1, further comprising generating the newsletter template prior to generating the newsletter, wherein generating the newsletter template comprises:
generating a user interface configured to:
display one or more sections of the newsletter template, comprising a title section and a content section; and
receive a user input to modify the one or more sections of the newsletter template; and
transmitting the user interface to an editor device.

13. The method of claim 12, wherein the content section comprises a placeholder section for one or more of an article title, a placeholder section for an article summary, a placeholder section for an article hyperlink, a placeholder section for an announcement, and a placeholder section for an advertisement.

14. The method of claim 12, wherein the user interface is configured to receive a drag and drop editing user input.

15. The method of claim 12, wherein the user interface is configured to display a user interface element corresponding to the one or more sections of the newsletter template, wherein the user interface element is configured to receive code editing user input.

16. The method of claim 7, wherein receiving the user input comprises:
generating a user interface configured to:
display a title section and a content section of the newsletter;
display a user interface element corresponding to the title section and content section of the newsletter, wherein the user interface element is configured to receive code editing user input; and
receive a user input to modify the title section or content section of the newsletter; and
transmitting the user interface to the editor device.

17. The method of claim 16, wherein:
the one or more user interface elements are configured to receive code input instructing modifications to the corresponding one or more sections of the newsletter;
and the one or more user interface elements are configured to receive code input formatted in at least one of an HyperText Markup Language (HTML), Cascading Style Sheets (CSS), or JAVA format.

18. The method of claim 16, wherein the content section comprises one or more of a section for an article title, a section for an article summary, a section for an article hyperlink, a section for an announcement, and a section for an advertisement.

19. A computer-implemented method for automated newsletter generation, comprising:
automatically receiving a plurality of articles that are associated with a topic, each of the plurality of articles associated with one or more titles for a plurality of newsletters;
for each title of the one or more titles:
automatically receiving a ranking of a portion of articles in the plurality of articles that are associated with the title, the ranking based on relevancy scores associated with each article in the portion of articles that indicate how relevant each article is to the title, the ranking produced using a first prompt or topic filter for a platform that comprises an artificial intelligence tool;
automatically receiving summaries of the portion of articles, wherein each summary of the summaries is for one of the portion of articles, the summaries produced using a second prompt for the platform;
automatically populating a newsletter template associated with the title with content to produce a newsletter, wherein the content comprises at least a portion of the summaries of the portion of the articles and the at least the portion of the summaries is based on the ranking of each article in the portion of articles; and
automatically transmitting the newsletter to an output channel to be received by a plurality of recipients.

20. An automated newsletter generation system, comprising:
a processor; and
a non-transitory computer-readable memory storing instructions that, when executed by the processor, cause the processor to:
identify, based on a title of a newsletter, a plurality of articles that are associated with a topic at or near a publication date of the newsletter;
generate a ranking of the plurality of articles based on relevancy scores associated with each article in the plurality of articles that indicate how relevant each article is to the topic, wherein the ranking of the plurality of articles utilizes a first prompt for a platform that comprises an artificial intelligence tool;
generate a plurality of summaries of the plurality of articles, wherein each summary of the plurality of summaries is for one of the plurality of articles, and wherein the generating of the plurality of summaries utilizes a second prompt for the platform;
generate the newsletter by populating a newsletter template associated with the newsletter with content to produce the newsletter, wherein the content comprises at least a portion of the summaries of the plurality of articles, wherein the at least the portion of the summaries of the plurality of articles is based on the ranking of the plurality of articles; and
transmit the newsletter to an output channel to be received by a plurality of recipients.
